(19) United States
(12) Patent Application Publication
(10) Pub. No.: US 2026/0371273 A1
(43) Pub. Date: Nov. 19, 2026

(54) SYNCHRONIZED TRANSMISSION OF UPLINK COMMUNICATIONS

(71) Applicant: T-MOBILE INNOVATIONS LLC, Overland Park, KS (US)

(72) Inventor: Anthony Samuel Jones, III, Ewa Beach, HI (US)

(21) Appl. No.: 19/211,551

(22) Filed: May 19, 2025

(51) Int. Cl. H04W 56/00; H04W 72/1268

(52) U.S. Cl. CPC H04W 56/0045; H04W 72/1268

(57) ABSTRACT

Systems, methods, and software are disclosed herein for synchronized communication by multiple UEs in a wireless communication network in various implementations. In one example, a UE identifies one or more UEs within a proximity of the UE and sends a request to each of the one or more UEs to perform a synchronized transmission of an uplink communication to an access node. The UE sends instructions for performing the synchronized transmission of the uplink communication to the one or more UEs. The UE performs at least a portion of the synchronized transmission of the uplink communication.

### TECHNICAL FIELD

Aspects of the disclosure are related to the field of wireless communication networks, particularly user equipment (UE) transmissions to access points in wireless networks.

### BACKGROUND

In a wireless communication network, a user equipment (UE) may be unable to connect with an access node due to limited coverage, signal attenuation, or poor radio conditions. This can occur in remote areas where network infrastructure is sparse, but also in obstructed environments where buildings, terrain, or interference degrade signal strength and quality. As a result, the UE may fail to detect a usable cell or may be unable to complete the initial access and authentication procedures required for network service.

Deploying access nodes in remote or low-density areas presents several challenges. These include the high cost of infrastructure deployment, limited access to power and backhaul connectivity, and lower user density, which reduces the economic incentive for network operators. Satellites with onboard serving cells have emerged as a viable alternative, offering wide-area coverage without the need for ground-based infrastructure. However, satellite-based serving cells face limitations high latency, weak uplink capability from UEs, and poor indoor penetration. While coverage issues continue to be mitigated as terrestrial and non-terrestrial networks proliferate, there remain geographic areas where a UE may be unable to reliably establish or maintain a network connection due to extreme distance, environmental conditions, or device limitations.

### OVERVIEW

Technology is disclosed herein for synchronized communication by multiple UEs in a wireless communication network in various implementations. In one example, a UE including one or more computer readable storage media, one or more processors operatively coupled with the one or more computer readable storage media and program instructions stored on the one or more computer readable storage media that, when executed by the one or more processors, direct the UE to operate as follows. The UE identifies one or more UEs within a proximity of the UE and sends a request to each of the one or more UEs to perform a synchronized transmission of an uplink communication to an access node. The UE sends instructions for performing the synchronized transmission of the uplink communication to each of the one or more UEs. The UE then performs at least a portion of the synchronized transmission of the uplink communication.

In another example, a method of operating a UE includes identifying one or more UEs within a proximity of the UE and sending a request to each of the one or more UEs to perform a synchronized transmission of an uplink communication to an access node. The method further includes sending instructions for performing the synchronized transmission of the uplink communication to each of the one or more UEs. The method further includes performing at least a portion of the synchronized transmission of the uplink communication.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for synchronized communication in a wireless network in an implementation.

FIG. 2 illustrates a process for synchronized uplink transmission for wireless communication in an implementation.

FIG. 3 illustrates a user experience for synchronized uplink transmission for wireless communication in an implementation.

FIG. 4 illustrates a user experience for synchronized uplink transmission for wireless communication in an implementation.

FIG. 5 illustrates an operational environment for synchronized uplink transmission by a calling UE and another UE for wireless communication in an implementation.

FIG. 6 illustrates a workflow for synchronized uplink transmission for wireless communication in an implementation.

FIG. 7 illustrates an example of an architecture of a UE in a 5G communication network.

FIG. 8 illustrates an operational architecture of a wireless communication system in an implementation.

FIG. 9 illustrates an operational architecture for a wireless communication network architecture in an implementation.

### DETAILED DESCRIPTION

Although the descriptions provided herein may be in the context of certain radio access technologies, networks, and network topologies, such as 5GNR (Fifth Generation New Radio) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Various implementations are disclosed herein for establishing a cellular connection between a UE and an access node of a wireless network in a poor radio frequency (RF) environment by orchestrating simultaneous signal transmission by multiple UEs to boost the transmission power of uplink signaling to the access node. Thus, in a poor RF environment, when a single device is unable to establish a cellular connection to a serving cell, if other devices are nearby, the single device can coordinate the signaling activity of the other devices to produce a stronger signal for uplink communications. Indeed, the transmission power of four UEs for a synchronized transmission may quadruple that of a single device. By enabling the multiple devices to emulate the uplink signaling of the single device, users in remote locations with weak or no cellular coverage may be able to communicate with an otherwise inaccessible access node to establish network connectivity.

In an exemplary scenario, a group of users stranded in a geographic location are unable to individually use their cellphones to establish a cellular connection with an access node of a wireless network due to weak signal coverage. However, a single cellphone or UE among the group of devices can place a call for emergency assistance by synchronizing the transmission of uplink signaling by the other devices to the access node. “Uplink transmission” as used herein includes the transmission of one or more uplink communications or signals by a device to an access node. To synchronize the uplink transmission by the other devices, the mobile originating or calling UE first detects other UEs that are proximal to the calling UE over an air interface such as a short-range device-to-device (D2D) communication protocol or technology such as Wifi Direct or Bluetooth. The calling UE transmits a request via the air interface to the other UEs to participate in synchronized signal transmission for placing the emergency call. When the other UEs accept the request, instructions for transmitting the uplink signaling for attachment to the access node, establishing the call session, authentication, and so on are relayed to the devices. In some scenarios, the calling UE may transmit a software application to each of the other devices that enables the calling UE to orchestrate the actions of the other devices with respect to communicating with the access node.

Continuing with the exemplary scenario, at an appointed time, the calling device and the other devices perform a simultaneous, synchronized transmission of the uplink signaling to the access node. By synchronizing the transmissions of the devices to the access node, the transmission power of the synchronized transmission is boosted based on the constructive interference of the simultaneous signaling, making successful attachment to and interaction with the access node more likely. The access node “sees” a transmission by a single device—the calling device—and a cellular connection with that device is established. Downlink communications from the access node are received by the calling device which continues to transmit uplink communications via synchronized transmission by the other UEs. In some scenarios, the application or instructions deployed by the calling UE to the other UEs may restrict the use of synchronized transmission to emergency communications (e.g., 911 calls, 911 messaging).

In an implementation, to orchestrate an uplink signal transmission, the calling UE executes an application which displays a user interface where the user can view and select other, nearby UEs for participating in the synchronized transmission. When another UE is selected, the application transmits a request to the selected UE via an air interface to allow the calling UE to control uplink transmission by the selected device. When the selected UE receives the request, the device may display the request along with an input device (e.g., button) by which the user can accept or reject the request. When the request is accepted, the application sends instructions for the transmission by the selected UE. The instructions may include the message content and a reference timing signal. The message content is a duplicate of the message content to be sent by the calling UE so that when the message is received by the access node, the access node initiates a call session for the calling device rather than the selected device. In other words, the message content identifies the calling UE as the device that is originating the message. In some cases, the instructions transmitted to the selected device cause a previously installed software application for synchronized transmission to be launched on the selected device when the device receives or accepts the request. In other scenarios, the instructions transmit an application which is launched by the selected UE. When the selected UEs have received the transmission instructions from the calling UE, the call is placed, and the applications executing on the selected devices display a status of communications with the access node in a user interface on the respective devices.

In various implementations, when the calling UE identifies other devices for synchronized uplink transmission, the calling UE polls the other devices for transmission capability, such as transmission power, transmission frequency bands, signal modulation (e.g., time division duplex, frequency division duplex), availability (e.g., time or time slots available for transmission), and so on. In some implementations, the devices participating in synchronized transmission can include cellphones (e.g., smartphones) but can also include other devices with cellular connectivity capability, such as Internet-of-Things (IoT) devices, laptop computers, tablet computers, residential Internet access points, and the like. The access node receiving the synchronized transmissions may be ground-based, airborne, or satellite-based.

Technical effects of the technology disclosed herein include leveraging the availability of multiple devices for synchronized signal transmission in environments where a single UE, such as a cellphone, may lack sufficient transmission power to connect with an access node. A lack of sufficient transmission power may occur when a cellphone is far from an access node (e.g., rural area, edge of a coverage zone) or in a location where signal attenuation is high and signal-to-noise ratio (SNR) is poor (e.g., underground garage, thick-walled building). Additionally, if the battery is critically low or the device is thermally constrained, the UE may limit its own transmission power, preventing successful connection. In these situations, synchronized transmission of uplink signaling via multiple other UEs in the vicinity of the UE can enable the UE to connect with the access node for network service, such as a voice call or text messaging. Further, in some scenarios, the use of synchronized transmission may be limited to emergency communications (e.g., 911 calls) to ensure the technology is not misused.

Moreover, in scenarios where the only nearest available access node is a non-terrestrial serving cell, such as a satellite-based cell, the window of access for connecting with the satellite cell is typically limited to the duration during which the satellite's beam footprint covers the UE's location. This window may be further constrained by the UE's limited uplink transmission power (“uplink budget”), which can reduce the effective communication range and shorten the usable portion of the access period, particularly at the edges of the beam or during low elevation passes. By synchronizing signal transmission by multiple UEs, the increase in transmission power effectively increases the uplink budget and the window of access, improving the likelihood of successful attachment and establishment of network connectivity.

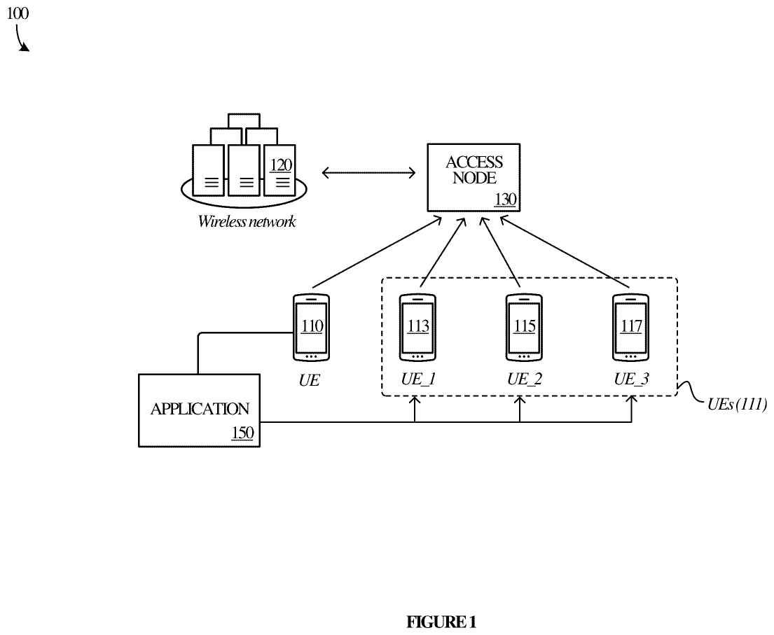

Turning now to the Figures, FIG. 1 illustrates operational environment 100 for synchronized communication by multiple UEs with a wireless network in an implementation. Operational environment 100 includes wireless network 120; access node 130; UE 110 (“UE 110”); UEs 113, 115, and 117 (collectively, UEs 111); and application 150 executing on UE 111.

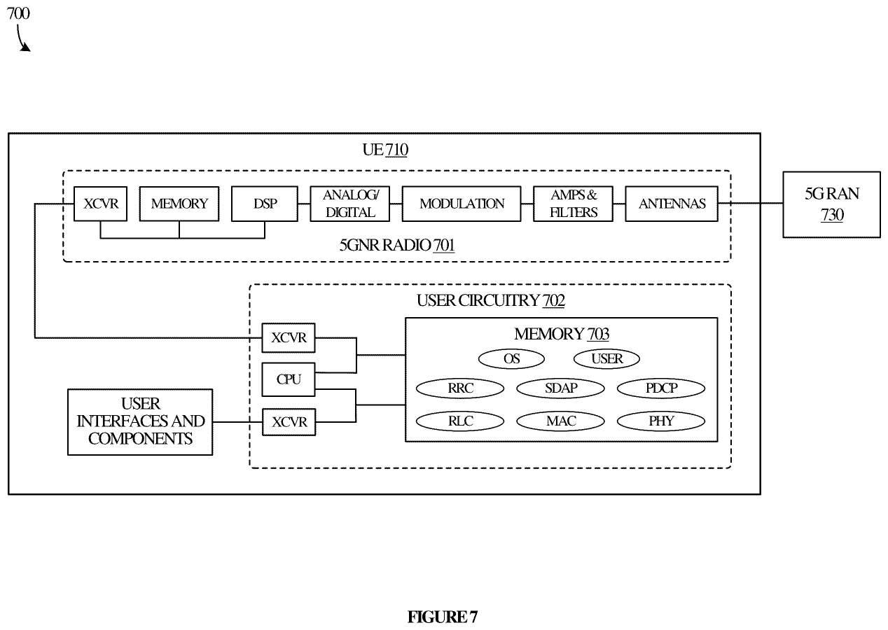

Each of UE 110 and UEs 111 is representative of a device, such as a smartphone, computer, sensor, controller, radio, and/or other user apparatus, with processing circuitry for wireless communication with wireless network 120 via access node 130 using protocols such as Fifth Generation New Radio (5GNR), 5G Advanced, LTE, 6G, Institute of Electrical and Electronic Engineers (IEEE) 902.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 110 and UEs 111 can also include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which UE 710 of FIG. 7 is one example. UE 110 and UEs 111 exchange wireless communication signals with access node 130 of wireless network 120 over radio frequency bands. In some examples, functionality attributed to a UE such as UE 110 or one of UEs 111 is distributed between or amongst multiple physical devices. For example, a mobile handset may be augmented with satellite connectivity using an auxiliary device which enables direct-to-satellite connectivity.

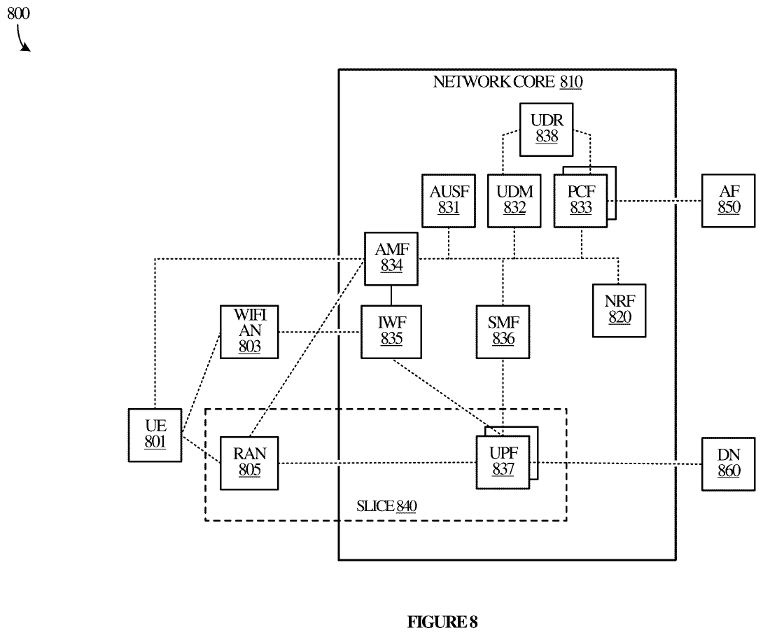

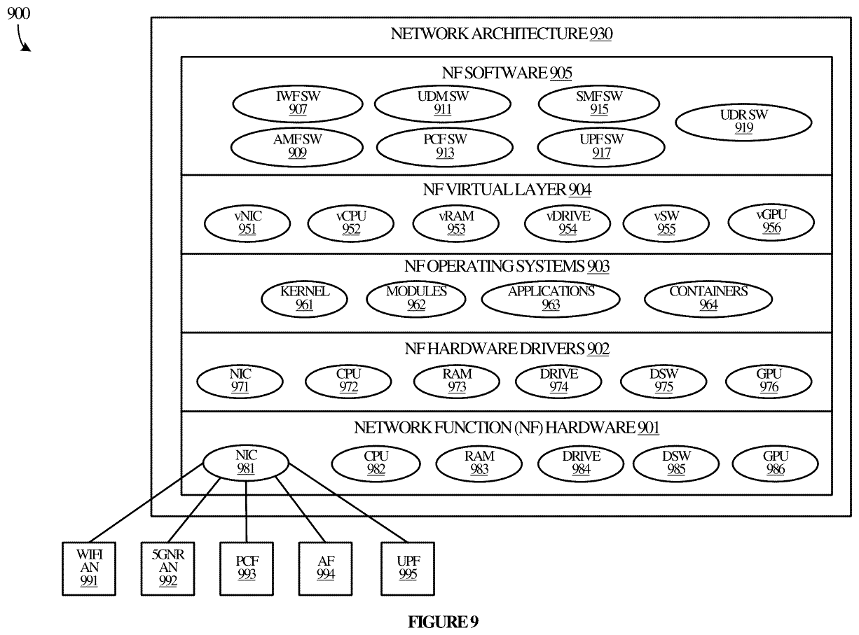

Wireless network 120 is representative of a communication network capable of using a Fifth Generation New Radio (5G-NR), LTE, 6G, or other protocol to communicate with computing devices such as UE 110 and UEs 111. In an implementation, wireless network 120 is representative of a service-based architecture (SBA) which includes network functions which constitute the control plane and user plane of a wireless communication network core, of which network core 810 of FIG. 8 and network architecture 930 of FIG. 9 are representative. The network functions of wireless network 120 are implemented on one or more suitable computing devices such as server computers, blade servers, and the like. The network elements of wireless network 120 may be implemented in the context of one or more data centers in a co-located or distributed manner, or in some other arrangement.

Access node 130 is representative of equipment, such as access nodes of Fifth Generation (5G) radio access networks (RANs), access nodes of long-term evolution (LTE) RANs, gNodeBs, eNodeBs, macrocells, NB-IoT access nodes, LP-WAN base stations, wireless relays, Wifi access nodes, and/or other wireless or wireline network transceivers. Access node 130 hosts access networks using radio frequencies to provide wireless network connectivity to devices. To communicate with a network core of wireless network 120, cells or base stations such as access node 130 include receiving unit (RU) circuitry which communicates along fronthaul data paths to distributed unit (DU) circuitry which in turn communicates with central unit (CU) circuitry along midhaul data paths. Access node 130 can include terrestrial configurations such as cell towers and small cells, as well as non-terrestrial configurations including on-orbit access nodes, such as satellite-based systems operating as part of an NTN architecture. Other configurations of access node 130 include cell towers, rooftop installations, small-cell sites, distributed antenna systems, vehicle-mounted systems, airborne access nodes, and the like.

Application 150 is representative of a functionality implemented in software or hardware executing onboard a UE such as UE 110 for synchronizing activity of multiple UEs for wireless communication with a wireless network. In an implementation, application 150 includes functionality for device-to-device (D2D) communication with other UEs (e.g., UEs 111) via a D2D air interface such as a Wifi Direct, Bluetooth, 5G Sidelink, Near Field Communication (NFC), Zigbee, and so on. Application 150 running locally with respect to UE 110 may be a natively installed and executed application, a browser-based application, or other type of application capable of providing a user experience displayed in a user interface of UE 110 in relation to synchronized communication activities.

In a brief operational scenario of operational environment 100, UE 110 discovers access node 130 (e.g., detects synchronization signals broadcast by access node 130) and attempts to establish a network connection but lacks sufficient transmission power to do so. Failure to establish a network connection may be due to factors such as excessive distance from access node 130, signal attenuation caused by physical obstructions, poor SNR, high uplink interference, or device-imposed transmission power limits resulting from low battery or thermal constraints. Application 150 executes on UE 110 to coordinate with one or more of UEs 111 to perform synchronized transmission of radio resource signaling to establish a network connection with access node 130, enabling access to network services. Application 150 may be manually launched on UE 110, or application 150 may launch automatically based on the device, for example, when the device fails to attach to access node 130.

Application 150 displays a user interface (e.g., on a display screen of UE 110) for synchronizing transmission activity of UE 110 and one or more other UEs for wireless communication with access node 130, for example, to initiate a voice call or transmit a text message. Application 150 discovers other UEs (e.g., UEs 111) within a proximity (e.g., detectable range) of UE 110 through wireless signaling exchanges over the D2D air interface. Application 150 displays the detected UEs in the user interface and prompts the user to select one or more of the displayed devices to receive a request for access for synchronized transmission. (For the sake of illustration, it will be assumed that the user selects all of UEs 111.) Upon receiving the user's selections, application 150 transmits a request to each of the selected UEs to perform synchronized transmission of radio resource signaling to establish a network connection with access node 130, for example, for initiating a voice call, exchanging messages, or accessing data services. In some scenarios, application 150 may limit the request for access to emergency communications such as 911 calls or messaging.

Upon receiving the request for access for synchronized transmission from UE 110, a selected UE (e.g., UE 113 of UEs 111) displays the request in its user interface where the user of that device can accept or reject the request. When the user accepts the request, UE 110 receives the acceptance from UE 113 and begins transmitting instructions to UE 113 for synchronized transmission. The instructions may include information about how the transmission is to be performed (e.g., frequency band, modulation, timing of transmission). The instructions may also include information to be transmitted simultaneously by the devices participating in the synchronized transmission. The information to be transmitted by the participating UEs can include copies of the message content to be sent by UE 110 to establish network service via access node 130, such as Radio Resource Connection (RRC) messages, attach or registration requests, authentication and security messages, session creation or establishment messages, and the like. The message content transmitted by the participating UEs can include control-plane signaling content as well as user-plane content.

In some scenarios, application 150 determines the parameters relating to how the synchronized transmission is to be performed by polling each of UEs 111 for information about their transmission capabilities, such as frequency bands, modulation, and availability. In some cases, a frequency band may be dedicated for use for synchronized uplink transmission by multiple UEs or for synchronized uplink transmission by multiple UEs for emergency communications.

In participating in synchronized transmission, UE 113 and the other participating UEs emulate UE 110 by transmitting uplink communications to access node 130 as if they are UE 110, including transmitting a device identifier associated with UE 110 (rather than sending a device identifier of the transmitting device). The device identifier of UE 110 that is sent by UE 113 can include a temporary identifier such as a GUTI (Global Unique Temporary Identifier) or SUCI (Subscriber Unique Concealed Identifier) or a permanent identifier such as an IMSI (International Mobile Subscriber Identity) or SUPI (Subscriber Permanent Identifier). In some scenarios, UE 113 launches an application for communication with application 150 when UE 113 receives the request for access from UE 110. In other scenarios, the instructions sent by UE 110 includes an application for communication with application 150. In either case, the application executes onboard UE 113 which interfaces with application 150 for performing the synchronized transmission as orchestrated by UE 110. The application may include program instructions which cause UE 113 to perform a synchronized uplink transmission at an appointed time or which cause UE 113 to await and receive a signal from UE 110 to perform a synchronized uplink transmission.

With participating UEs identified, UE 110 initiates the synchronized transmission of an uplink communication to access node 130 by the multiple UEs. To initiate the synchronized transmission, UE 110 may send a signal to UEs 111 triggering the simultaneous transmission of an uplink communication by those devices, or UE 110 may provide a clock time for the synchronized transmission. As a result, the transmission power of the synchronized transmission will be based on a combination of the transmission power of UE 110 and the transmission power of each of UEs 111. With each device transmitting identical information simultaneously, access node 130 receives the uplink communication and establishes network connectivity with UE 110.

When access node 130 communicates with UE 110, various ones of UEs 111 may receive the downlink communication, providing multiple pathways by which UE 110 can receive communication from access node 130. For example, when UE 113 receives a downlink communication from access node 130, UE 113 may relay the information to UE 110 via a D2D interface, providing redundancy in the downlink communication.

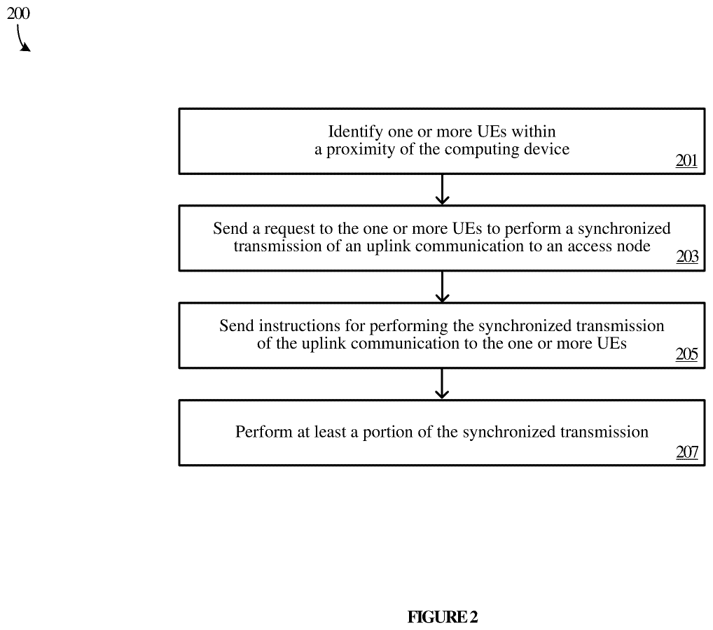

FIG. 2 illustrates a method of synchronized transmission by multiple devices in wireless communication networks in an implementation, referred to herein as process 200. Process 200 may be implemented in program instructions in the context of any of the software applications, modules, components, or other such elements of a UE. The program instructions direct the UE to operate as follows.

In process 200, a UE identifies one or more UEs within a proximity of the UE (step 201). In an implementation, a UE, such as a smartphone or other computing device with processing circuitry for wireless communication with a wireless network, identifies one or more other UEs proximal to the UE, that is, that are within a detectable range of the UE according to a D2D technology or protocol such as Wifi Direct, Bluetooth, or the like.

The UE sends a request to the one or more UEs to perform a synchronized transmission of an uplink communication to an access node (step 203). In an implementation, the UE sends a request to the other UEs to access the transmission functionality of those devices to participate in a synchronized transmission of an uplink communication. The request may include information about the type of access requested, such as access for a voice call, messaging, or other network service. In some scenarios, the request may indicate that the access is requested on a temporary or emergency basis. The request may cause each of the other UEs to display the request in its user interface where the respective user can accept or decline the request. In some cases, a UE receiving the request may be configured to automatically respond to such a request, for example, if the request indicates that the access is for transmitting an emergency communication. The message content of the uplink communication can include requests to attach to the access node, requests to establish a Session Initiation Protocol (SIP) session for network service, authentication communications, security communications, and so on. The uplink communication may include an indication that the message originates from the UE requesting network service, such as a device identifier of the UE.

The UE sends instructions to the one or more UEs for performing the synchronized transmission of the uplink communication (step 205). In an implementation, the UE transmits message content of the synchronized uplink transmission to the other UEs. Because the UE requesting network service would normally exchange multiple signals in the process of attaching to the network, establishing network service, and so on, the uplink message content for each of the multiple signals may be transmitted to the devices individually or in combination. In some scenarios, the devices may be instructed to emulate the UE, providing the appropriate device identifiers and other information by which the devices can configure the uplink message content. The instructions for transmission may also include transmission parameters such as the frequency band for transmission, the modulation, and when the transmission is to occur.

In some cases, the UE and the one or more other UEs interact via software applications for synchronized transmission executing onboard the respective devices. For example, the instructions for a synchronized transmission may be received by an application on the other UEs from an application on the UE. The interaction between the applications on the various devices may facilitate an ongoing distribution of message content (e.g., control plane and user plane data) from the UE to the other UEs for multiple uplink communications and for triggering synchronized transmission by providing a designated clock time for transmission or by sending a firing signal for transmission.

The UE performs at least a portion of the synchronized transmission (step 207). In an implementation, the UE initiates a synchronized uplink transmission by the other, participating UEs while simultaneously transmitting the uplink communication itself. The synchronized transmission thus includes the simultaneous transmissions by the UE and the participating UEs. The synchronized transmission will include signals from each device contributing to the effective transmission signal power that is greater than the transmission power of any single device, increasing the likelihood of the access node receiving the uplink communication. To initiate simultaneous transmission, the UE may designate a clock time for signal transmission, or the UE may transmit a signal to the UEs which causes the participating UEs to transmit the uplink communication.

Referring again to FIG. 1, a brief example of process 200 as employed by elements of operational environment 100 follows. In operation, application 150 executing on UE 110 identifies UEs 111 in the vicinity of UE 110. Application 150 sends a request to each of UEs 111 to perform a synchronized transmission of an uplink communication to access node 130. When application 150 receives an acceptance of the request from various ones of UEs 111, application 150 sends transmission instructions to the participating ones of UEs 111. At a designated time, application 150 causes UE 110 and the participating ones of UEs 111 to transmit identical uplink communications simultaneously.

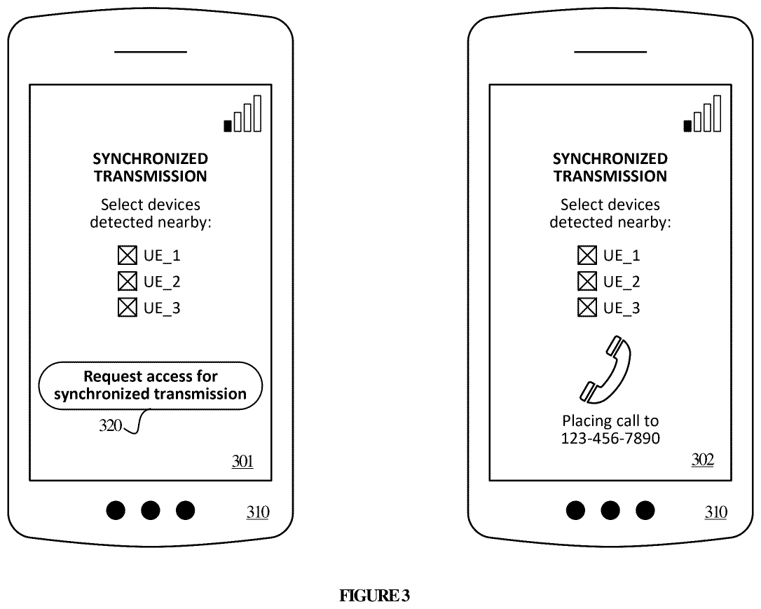

FIG. 3 illustrates user experiences 301 and 302 for an application for synchronized transmission by multiple UEs in a wireless network system in an implementation. User experiences 301 and 302 are displayed on UE 310 of which UE 110 of FIG. 1 is representative. Although UE 310 is depicted as a cellphone, it may be appreciated that UE 310 can include a computing device with processing circuitry for wireless communication with an access node of a wireless network.

In user experience 301, an application for synchronized transmission is displayed in the user interface of UE 310. The application detects or discovers other UEs in the vicinity of UE 310 (e.g., via a D2D interface) and displays device identifiers of the detected devices in the user interface. The application receives user input comprising selections of one or more devices from which to request access for synchronized transmission. (As illustrated, the user has selected each of the detected devices “UE_1,” “UE_2,” and “UE_3” by ticking the respective checkboxes.)

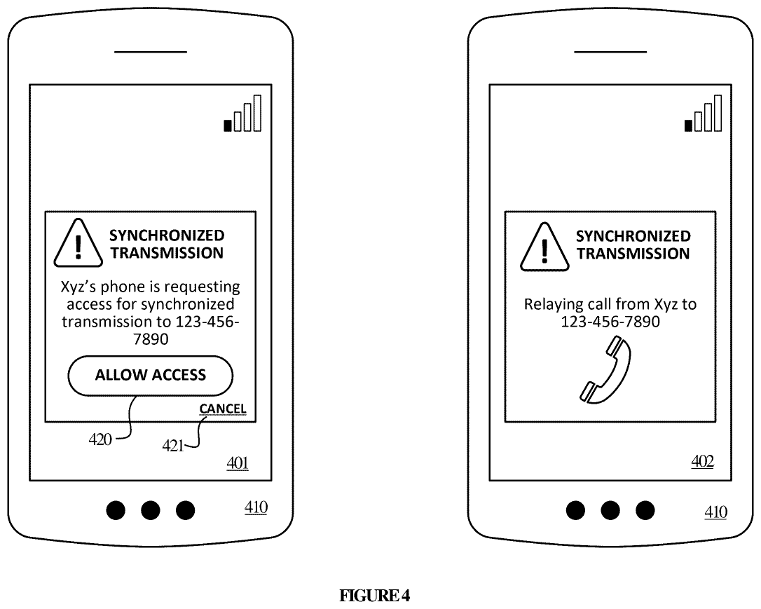

When the user selects button 320 in the user interface, the application sends a message to each of the selected devices via a D2D interface requesting access to or control of the devices for synchronized transmission of uplink communications to an access node. The request may be received by and displayed in a user interface of an application executing on the selected devices, of which user experiences 401 and 402 of FIG. 4 are one example. After the application receives responses to the request from the various ones of the detected devices, UE 310 transmits uplink communication instructions to the participating devices. UE 310 may also poll the participating devices to determine the transmission capabilities of the devices, for example, to identify a frequency band capability that is common to all the participating devices. The identified frequency band may be included in the uplink communication instructions.

At a designated time, UE 310 initiates the synchronized uplink transmission by UE 310 and the participating ones of the detected devices in which each device performs a portion of the synchronized uplink transmission. UE 310 displays user experience 302 providing a status of the uplink transmission. User experience 302 may also display other information relating to the synchronized transmission, such as displaying a status of the requests sent to the detected devices or the dialed number.

FIG. 4 illustrates user experiences 401 and 402 for a client application for synchronized uplink transmission by multiple UEs in a wireless network system in an implementation. User experiences 401 and 402 are displayed on UE 410 of which UE 113 of FIG. 1 is representative. Although depicted as a cellphone, it may be appreciated the UE 410 may be a computing device with processing circuitry for wireless communication with an access node of a wireless network.

In user experience 401, an application for synchronized uplink transmission is displayed in the user interface of UE 410 when a request is received from another device (e.g., UE 310 of FIG. 3) to participate in a synchronized uplink transmission. The application displays button 420 by which the user of UE 410 can accept the request and hyperlink 421 by which to cancel (reject) the request.

When the user selects button 420, the application returns a message via a D2D interface to the requesting device. Upon accepting the request, the application receives instructions for the synchronized uplink transmission (e.g., message content, transmission parameters) from the requesting device. The message content is configured according to the perspective of the requesting device so that when transmitted by UE 410, the access node receiving the message will understand the message as originating from the requesting device rather than from UE 410.

Continuing with user experience 402, the application displays the status of the uplink transmission including the dialed number. In some scenarios, the request for access transmitted by a calling UE 310 to UE 410 may be restricted to emergency communications, and the emergency status of the communication may also be indicated in user experience 401 or 402.

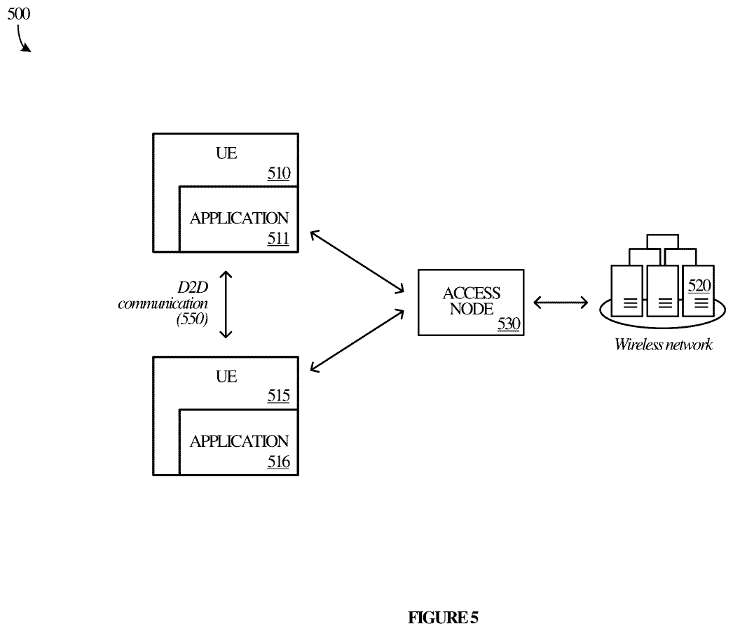

FIG. 5 illustrates operational environment 500 for synchronized transmission by multiple UEs for device communication with a wireless network in an implementation. Operational environment 500 includes wireless network 520, access node 530, UE 510 running application 511, and UE 515 running application 516.

Each of UE 510 and UE 515 is representative of a device, such as a smartphone, computer, sensor, controller, radio, and/or other user apparatus, with processing circuitry for wireless communication with wireless network 520 via access node 530 using protocols such as Fifth Generation New Radio (5GNR), 5G Advanced, LTE, 6G, Institute of Electrical and Electronic Engineers (IEEE) 902.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 510 and UE 515 can also include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which UE 710 of FIG. 7 is one example. UE 510 and UE 515 exchange wireless communication signals with access node 530 of wireless network 520 over radio frequency bands. In some examples, functionality attributed to a UE such as UE 510 or UE 515 is distributed between or amongst multiple physical devices. For example, a mobile handset may be augmented with satellite connectivity using an auxiliary device which enables direct-to-satellite connectivity.

UE 510 executes application 511 for synchronizing uplink transmission by multiple UEs with respect to communication with a wireless network. In an implementation, application 511 includes functionality for D2D communication 550 with application 516 on UE 515 via an air interface such as a Wifi Direct, Bluetooth, 5G Sidelink, NFC, Zigbee, and so on. Application 511 running locally with respect to UE 510 may be a natively installed and executed application, a browser-based application, or other type of application capable of providing a user experience displayed in a user interface of UE 510 in relation to synchronized communication activities.

UE 515 executes application 516 for synchronizing uplink transmission by multiple UEs with respect to communication with a wireless network. In an implementation, application 516 includes functionality for D2D communication 550 with application 511 on UE 510 via an air interface such as Wifi Direct, Bluetooth, 5G Sidelink, NFC, Zigbee, and so on. Application 516 running locally with respect to UE 515 may be a natively installed and executed application, a browser-based application, or other type of application capable of providing a user experience displayed in a user interface of UE 515 in relation to synchronized communication activities.

Wireless network 520 is representative of a communication network capable of using a Fifth Generation New Radio (5G-NR), LTE, 6G, or other protocol to communicate with computing devices such as UE 510 and UE 515. In an implementation, wireless network 120 is representative of a service-based architecture (SBA) which includes network functions which constitute the control plane and user plane of a wireless communication network core, of which network core 810 of FIG. 8 and network architecture 930 of FIG. 9 are representative. The network functions of wireless network 520 are implemented on one or more suitable computing devices such as server computers, blade servers, and the like. The network elements of wireless network 520 may be implemented in the context of one or more data centers in a co-located or distributed manner, or in some other arrangement.

Access node 530 is representative of equipment, such as access nodes of Fifth Generation (5G) radio access networks (RANs), access nodes of long-term evolution (LTE) RANs, gNodeBs, eNodeBs, macrocells, NB-IoT access nodes, LP-WAN base stations, wireless relays, Wifi access nodes, and/or other wireless or wireline network transceivers. Access node 530 hosts access networks using radio frequencies to provide wireless network connectivity to devices. To communicate with a network core of wireless network 520, cells or base stations such as access node 530 include receiving unit (RU) circuitry which communicates along fronthaul data paths to distributed unit (DU) circuitry which in turn communicates with central unit (CU) circuitry along midhaul data paths. Access node 530 can include terrestrial configurations such as cell towers and small cells, as well as non-terrestrial configurations including on-orbit access nodes, such as satellite-based systems operating as part of an NTN architecture. Other configurations of access node 530 include cell towers, rooftop installations, small-cell sites, distributed antenna systems, vehicle-mounted systems, airborne access nodes, and the like.

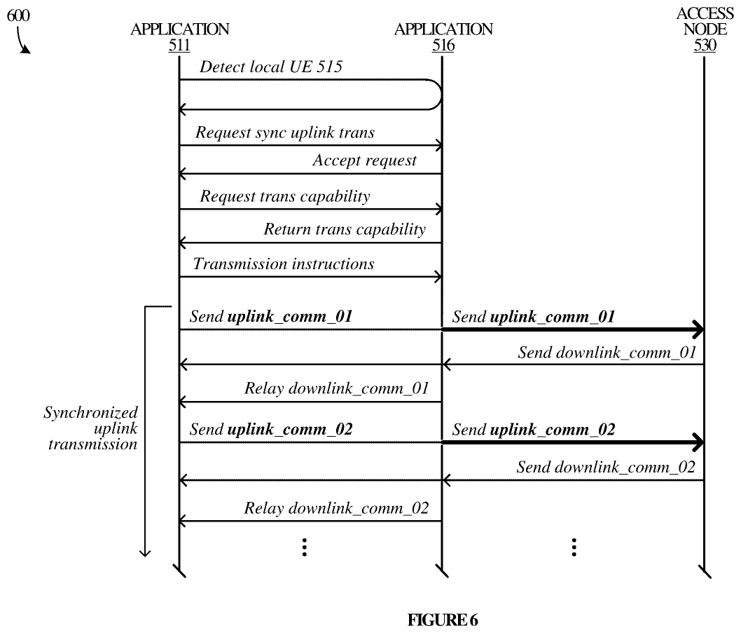

FIG. 6 illustrates workflow 600 for synchronized uplink transmission by multiple UEs for wireless communication with a wireless network in an implementation referring to elements of operational environment 500.

In operational environment 500, UE 510 discovers access node 530 but lacks sufficient transmission power to attach to access node 530 for network service. For example, UE 510 may be too far from access node 530 to reliably communicate with access node 530. UE 515 similarly lacks sufficient transmission power to communicate with access node 530. Application 511 is launched on UE 510 to enable synchronized uplink transmission for communication with access node 530 to establish network service with wireless network 520.

In workflow 600, application 511 detects UE 515 in the vicinity of UE 510 using a D2D interface such as Wifi Direct, Bluetooth, or the like. Application 511 sends a request to UE 515 to participate in synchronized uplink transmission to communicate with access node 530. In an implementation, UE 515 receives the request and displays the request the user interface of the device. UE 515 receives user input indicating an acceptance of the request and sends an indication of the acceptance to application 511.

In some implementations, the request from application 511 causes application 516 to launch on UE 515 to interface with application 511, and application 516 communicates with application 511, including transmitting an acceptance of the request to application 511, for performing the synchronized uplink transmission and relaying downlink communication back to UE 510.

Having received an acceptance from UE 515, application 511 polls UE 515 (or application 516 executing on UE 515) for the device's transmission capabilities. Application 511 ascertains transmission parameters (e.g., frequency band, modulation) which both devices support which can be used for the synchronized transmission.

Continuing with workflow 600, application 511 sends transmission instructions, including transmission parameters and messaging content, to UE 515 or to application 516 executing on UE 515. The transmission parameters include at least a device identifier for UE 510. Application 511 then initiates synchronized uplink transmission to access node 530 by causing UE 510 and UE 515 to transmit identical uplink messages simultaneously, with the uplink messages indicating the sender to be UE 510. Access node 530 receives the simultaneous uplink messages as a single message sent by UE 510 and returns a downlink communication in response. The downlink communication is received by UE 510 as well as UE 515. UE 515 relays the downlink communication to UE 510 providing redundancy for the downlink communication.

The synchronized uplink transmission continues, enabling UE 510 to attach to access node 530 and establish network service. Application 511 provides transmission instructions for each of the uplink communications prior to transmission, or the instructions may be provided in bulk before a sequence of uplink communications.

In some scenarios, the actions of applications 511 and 516 are interchangeable. That is, UE 515 may request access to UE 510 for performing synchronized uplink transmission, and application 516 may transmit the request, transmission instructions, and so on to application 511 for UE 510 to emulate UE 515.

FIG. 7 illustrates UE 710 in 5G network 700. UE 710 depicts an example of UE 110 and UEs 111 illustrated in FIG. 1, UE 310 of FIG. 3, UE 410 of FIG. 4, and UEs 510 and 515 of FIG. 5. UE 710 includes 5G radio 701 and user circuitry 702. 5G radio 701 includes 5GNR antennas, amplifiers, filters, modulation, analog-to-digital interfaces, Digital Signal Processers (DSP), memory, and transceivers (XCVRs) that are coupled over bus circuitry. User circuitry 702 includes memory 703, CPU, user interfaces and components, and transceivers that are coupled over bus circuitry.

Memory 703 of user circuitry 702 stores an operating system (OS), user applications (USER), and 5GNR network applications for PHY, MAC, RLC, PDCP, SDAP, and RRC. The antenna in 5G radio 701 is wirelessly coupled to 5G RAN 730 over a 5GNR link. Transceivers in 5G radio 701 are coupled to a transceiver in user circuitry 702. A transceiver in user circuitry 702 is typically coupled to user interfaces and components like displays, controllers, and memory.

In 5G radio 701, the antennas receive wireless signals from 5G RAN 730 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the digital signal processors (DSPs). The DSPs transfer corresponding 5GNR symbols to user circuitry 702 over the transceivers.

In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 730 that transport the uplink 5GNR signaling and data.

In memory 703, RRC functions include authentication, security, handover control, status reporting, Quality of Service (QoS), network broadcasts and pages, and network selection. SDAP functions comprise QoS marking and flow control. PDCP functions include security ciphering, header compression and decompression, sequence numbering and re-sequencing, de-duplication. RLC functions comprise Automatic Repeat Request (ARQ), sequence numbering and resequencing, segmentation and resegmentation. MAC functions include buffer status, power control, channel quality, Hybrid ARQ (HARQ), user identification, random access, user scheduling, and QoS. PHY functions include packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

FIG. 8 illustrates wireless communication system 800, an example of a wireless communication system that provides network service to wireless UE 801 of which UE 710 of FIG. 7 is one example. Wireless communication system 800 includes UE 801, Wifi Access Node (AN) 803, 5GNR RAN 805, Interworking Function (IWF) 835, Access and Mobility Management Function (AMF) 834, Authentication Server Function (AUSF) 831, Unified Data Management (UDM) 832, Policy Control Functions (PCFs) 833, Session Management Function (SMF) 836, User Plane Function (UPF) 837, Uniform Data Repository (UDR) 838, Application Function (AF) 850, and Network Repository Function (NRF) 820. UDR 838 stores network data including subscriber profiles including identities, subscription details, service preferences, authentication credentials, and billing information. UDR 838 may also store policy data such as network rules, access rules, mobility rules, charging rules, and so on. AF 850 may provide policies applicable to control plane functions, that is, to the application, presentation, and/or session layers of the OSI protocol stack. IWF 835 includes non-3GPP IWFs (N3IWFs) for providing untrusted non-3GPP access to network data center 810, such as access via a non-cellular access network.

Continuing with wireless communication system 800, wireless network slice 840 includes UPF 837 and SMF 836. Wireless network slice 840 is representative of a dynamically allocated slice of finite duration selected for hosting service from DN 860 to UE 801. DN 860 is representative of a data network, Internet access, third-party resource, or other endpoint of an end-to-end communication path from UE 801.

In an implementation, UE 801 communicates with network data center 810 via 5GNR access node 805 according to the technology disclosed herein, whereby multiple UEs (not shown) simultaneously transmit identical uplink communications originating from UE 801 to RAN 805 to provide sufficient transmission power for the uplink communication to reach RAN 805.

FIG. 9 illustrates exemplary network data center 930, a network core of wireless communication system 900. Network data center 930 includes network function (NF) software 905, network function virtual layer 904, network function operating systems 903, network function hardware drivers 902, and network function hardware 901.

Network function software 905 of network data center 930 includes software for executing various network functions: IWF software 907, AMF software 909, UDM software 911, PCF software 913, SMF software 915, UPF software 917, and UDR software 919. Other network function software, such as NRF software, are typically present but are omitted for clarity.

Network function virtual layer 904 includes virtualized components of network data center 930, such as virtual NIC 951, virtual CPU 952, virtual RAM 953, virtual drive 954, virtual software 955, and virtual GPU 956. Network operating systems 903 includes components for operating network data center 930, including kernels 961, modules 962, applications 963, and containers 964 for network function software execution. Network function hardware drivers 902 include software for operating network function hardware 901 of network data center 930, including network interface card (NIC) drivers 971 for network interface cards (NICs) 981, CPU drivers 972 for CPUs 982, RAM drivers 973 for RAM 983, flash/disk drive drivers 974 for flash/disk drives 984, data switch (DSW) drivers 975 for data switches 985, and drivers 976 for GPUs 986. Network interface cards 981 of network function hardware 901 include hardware components for communicating with Wifi access node 991, 5GNR access node 992, PCF 993, application server 994, and UPF 995.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A user equipment (UE) comprising:
one or more computer readable storage media;
one or more processors operatively coupled with the one or more computer readable storage media; and
program instructions stored on the one or more computer readable storage media that, when executed by the one or more processors, direct the UE to at least:
identify one or more user equipment (UEs) within a proximity of the UE;
send, to each of the one or more UEs, a request to perform a synchronized transmission of an uplink communication to an access node;
send, to each of the one or more UEs, instructions for performing the synchronized transmission of the uplink communication; and
perform at least a portion of the synchronized transmission of the uplink communication.

2. The UE of claim 1, wherein to perform at least the portion of the synchronized transmission, the program instructions direct the UE to:
direct the one or more UEs to transmit the uplink communication at a designated time; and
transmit the uplink communication at the designated time.

3. The UE of claim 1, wherein the program instructions further direct the UE to:
poll each of the one or more UEs for transmission capability; and
determine a frequency band for the synchronized transmission based on the transmission capabilities of the one or more UEs.

4. The UE of claim 1, wherein the uplink communication comprises a message content originating from the UE.

5. The UE of claim 4, wherein the message content includes a device identifier for the UE.

6. The UE of claim 1, wherein the uplink communication comprises an emergency communication.

7. The UE of claim 1, wherein a transmission power of the synchronized transmission is based on a combination of a transmission power of the UE and a transmission power of each of the one or more UEs.

8. A method of operating a user equipment (UE), comprising:
identifying one or more user equipment (UEs) within a proximity of the UE;
sending, to each of the one or more UEs, a request to perform a synchronized transmission of an uplink communication to an access node;
sending, to each of the one or more UEs, instructions for performing the synchronized transmission of the uplink communication; and
performing at least a portion of the synchronized transmission of the uplink communication.

9. The method of claim 8, wherein performing the synchronized transmission comprises:
directing the one or more UEs to transmit the uplink communication at a designated time; and
transmitting the uplink communication at the designated time.

10. The method of claim 8, further comprising:
polling each of the one or more UEs for transmission capability; and
determining a frequency band for the synchronized transmission based on the transmission capabilities of the one or more UEs.

11. The method of claim 8, wherein the uplink communication comprises a message content originating from the UE.

12. The method of claim 11, wherein the message content includes a device identifier for the UE.

13. The method of claim 8, wherein the uplink communication comprises an emergency communication.

14. The method of claim 8, wherein a transmission power of the synchronized transmission is based on a combination of a transmission power of the UE and a transmission power of each of the one or more UEs.

15. One or more computer readable storage media having program instructions stored thereon that, when executed by one or more processors of a computing device, direct the computing device to at least:
identify one or more user equipment (UEs) within a proximity of the computing device;
send, to each of the one or more UEs, a request to perform a synchronized transmission of an uplink communication to an access node;
send, to each of the one or more UEs, instructions for performing the synchronized transmission of the uplink communication; and
perform at least a portion of the synchronized transmission of the uplink communication.

16. The one or more computer readable storage media of claim 15, wherein to perform the synchronized transmission, the program instructions direct the computing device to:
direct the one or more UEs to transmit the uplink communication at a designated time; and
transmit the uplink communication at the designated time.

17. The one or more computer readable storage media of claim 15, wherein the program instructions further direct the computing device to:
poll each of the one or more UEs for transmission capability; and
determine a frequency band for the synchronized transmission based on the transmission capabilities of the one or more UEs.

18. The one or more computer readable storage media of claim 15, wherein the uplink communication comprises a message content originating from the computing device.

19. The one or more computer readable storage media of claim 18, wherein the message content includes a device identifier for the computing device.

20. The one or more computer readable storage media of claim 15, wherein the uplink communication comprises an emergency communication.
